(19) United States
(12) Patent Application Publication
(10) Pub. No.: US 2018/0244548 A1
(43) Pub. Date: Aug. 30, 2018

(54) USE OF COPPER-CARBON COMPOSITE NANOMATERIAL IN ALGAE CONTROL

(71) Applicant: Suzhou Guanjie Nano Anti-bacteria Coating Technology Co., Ltd., Suzhou (CN)

(72) Inventors: KUN LIAN, SUZHOU (CN); CHAO LI, SUZHOU (CN)

(73) Assignee: Suzhou Guanjie Nano Anti-bacteria Coating Technology Co., Ltd.

(21) Appl. No.: 15/967,444

(22) Filed: Apr. 30, 2018

Related U.S. Application Data
(63) Continuation of application No. PCT/CN2016/000320, filed on Jun. 20, 2016.

(30) Foreign Application Priority Data
Oct. 28, 2015 (CN) 201510711782.4

(51) Int. Cl. C02F 1/50; A01N 59/20

(52) U.S. Cl. CPC C02F 1/505; C02F 2103/42; A01N 59/20

(57) ABSTRACT

The present invention relates to a use of a copper-carbon composite nanomaterial in algae control. The copper-carbon composite, nanomaterial is applied in inhibition of algae growth. The copper-carbon composite nanomaterial achieves control of algal blooms by inhibiting algae growth, and does not generate secondary pollution during processing. By employing the copper-carbon composite nanomaterial to perform algae control, the present invention eliminates the pollution resulting from algal blooms, and improves the water environment.

### CROSS-REFERENCE TO RELATED APPLICATIONS

This application is a continuation of International Patent Application No. PCT/CN2016/000320 with a filing date of Jun. 20, 2016, designating the United States, now pending, and further claims priority to Chinese Patent Application No. 201510711782.4 with a filing date of Oct. 28, 2015. The content of the aforementioned applications, including any intervening amendments thereto, are incorporated herein by reference.

### TECHNICAL FIELD

The present invention relates to a use of a copper-carbon composite nanomaterial in algae control, and belongs to the field of environmental protection.

### BACKGROUND OF THE PRESENT INVENTION

Algal bloom refers to a natural ecological phenomenon that a large number of algae breed because a water body is eutrophicated due to enrichment of nutrients such as nitrogen, phosphorus and the like. Major factors that affect the formation of the algal bloom include: eutrophication of the water body, water temperature, pH value of the water body, light intensity and the like. From spring to summer, as the growth conditions of the algae are gradually improved, the biomass, of the algae is rapidly increased. When meteorological and hydrological preconditions are appropriate, the algal bloom may also break out.

The algae may also cause adverse effect on other aquatic organisms, resulting in imbalance of biological chain. For example, oxygen generated by photosynthesis of the large number of algae may enable dissolved oxygen in the water body to be in an over-saturated state, thereby increasing activity of thiaminase of fish bodies. Under the effect of the thiaminase, vitamin B1 is rapidly fermented and decomposed so that the fish bodies lack of the vitamin B1, the central nervous system and the peripheral nervous system fail and excitability is increased, causing that the fish bodies move rapidly, generate spasm and even lose body function balance. When a large number of algae become feeble and die, due to deterioration and decomposition, the dissolved oxygen in the water body may be consumed and may rise to a water surface to form a layer of green viscous substance; and the water body emits stink. When people make some water amusements and sports such as bath and swimming, people may suffer from skin allergy when contacting the water body that includes algal toxin; when people drink a small number of the water body, people may suffer from acute gastroenteritis; and liver cancer may be caused when people drink the water body for long.

The algae may also affect the development of aquaculture. Cage culture is a production mode for fish farming in which cages made of nets ere placed in waters. Generally, the cages are placed in waters such as lakes, rivers and reservoirs with water flows, fresh water and high quantity of dissolved oxygen, as well as proper ocean environment. After the net cages are placed in the water for a period of time, the algae may be attached to the nets to grow, thereby blocking meshes, affecting water exchange and adversely affecting the removal of faeces in the cages and the supply of natural baits and the like. At present, manual cleaning, mechanical cleaning and other methods are used for removing the algae. The growth of the algae can also be avoided by winding copper wires on the net wires, but too heavy weight of the net cages is not beneficial for suspension and handling operation of the net cages, bringing significant economic losses and affecting the development of the aquaculture.

80% of lakes and waters in China are attacked by the algal bloom caused by enrichment due to pollution of the water body, and the algal bloom with microcystis aeruginosa (cyanophyta) as dominant population has been the focus of people in China and abroad. In May of 2007, Tai Lake started to break out blue algae. Wuxi Municipal Government quickly took some measures organized mechanized salvage teams and invested RMB 41.5 billion to control the blue algae. In 2008, the algae separation station of Tai Lake of Wuxi with a total investment of more than RMB 5 million was built; by the end of 2009, 772 factories were closed; and in 2012, RMB 2.8 billion was invested. Although a drinking problem is solved currently and the blue algae are effectively controlled, a control process is slow and massive manpower, materials and finances are consumed.

The breakout of the blue algae of Tai Lake is not a special case. After this, the blue algae have broken out on 11st, June in Chao Lake of Anhui; and the blue algae have also broken out on 24th, June in Dian Lake of Yunnan. Later, the same problem occurred on 11st, July in East Lake of Wuhan where such large-scale blue algae pollution has not occurred within 20 years. By 2012, Anhui has invested more than RMB 50 billion for controlling the breakout of the blue algae of Chao Lake. In nine Plateau Pearls of Yunnan, Dian Lake is the most seriously polluted. Since 1993, more than RMB 4.7 billion has been invested to control the Dian Lake.

At present, treatment methods for the algal bloom in China and abroad mainly include a physical method, a chemical method and a biological method. The methods for treating the algae by means of chemical agents are used most often in the current world and are also mature algae removal technologies. These methods include a coagulation method, a copper sulfate method, an ozone method, a chlorine dioxide method end the like, wherein the copper sulfate method is applied most often. However, it is found in the application process that sometimes effects are not good, and a large number of algae appear again after dying. Drugs used currently do not have selective killing effect on the algae and other organisms, and also have obvious killing effect on other algae while killing the blue algae, thereby polluting the water body. Experiments show that the toxicity of copper sulfate is relevant to many factors; the higher the water temperature is, the larger the toxicity is; and when the water temperature is greater than 35° C., fishes may die and have potential safety hazard if the fishes are eaten, so the environment and human health are affected adversely.

Therefore, it is necessary to design a copper-carbon composite nanomaterial to overcome the above problems.

### SUMMARY OF PRESENT INVENTION

A purpose of the present invention is to provide a use of a copper-carbon composite nanomaterial in algae control, so as to overcome defects in the prior art. The copper-carbon composite nanomaterial achieves control of algal blooms by inhibiting algae growth, and does not generate secondary pollution during processing.

The present invention is realized as follows:

The present invention provides a use of a copper-carbon composite nanomaterial in algae control. The copper-carbon composite nanomaterial is used to inhibit algae growth.

Further, the copper-carbon composite nanomaterial used for algae control is a nanoparticle of a core-shell structure with copper-carbon component prepared by a plant fiber template.

Further, the concentration of the copper-carbon composite nanomaterial used for algae control is 50 ppm to 150 ppm.

Further, algae in outdoor pools are killed and controlled by throwing the copper-carbon composite nanomaterial, and the thrown copper-carbon composite nanomaterial is in powder form.

Further the copper-carbon composite nonmaterial comprises copper-carbon nano textile fibers or foam; and net cages used for cultivation and prepared by the copper-carbon nano textile fibers or foam can be used to effectively inhibit algae growth and avoid blocking meshes of the net cages due to algae growth.

The present invention has the following beneficial effects:

The copper-carbon composite nanomaterial achieves control of algal blooms by inhibit algae growth, and does not generate secondary pollution during processing. The copper-carbon composite nanomaterial is used for algae control, thereby eliminating pollution caused by algal blooms and improving water environment.

### DESCRIPTION OF THE DRAWINGS

To more clearly describe embodiments of the present invention or technical solutions in the prior art, drawings to be used in the description of the embodiments or the prior art are introduced simply. Apparently, the drawings in the following description are only some embodiments of the present invention. For those ordinary skilled in the art, on the premise that creative labor is not contributed other drawings can also be obtained according to these drawings.

FIG. 1 is a schematic diagram of α content of scenedesmus chlorophyll provided in embodiments of the present invention;

FIG. 2 is a schematic diagram of α content of chlorella chlorophyll provided in embodiments of the present invention;

FIG. 3 is a schematic diagram of α content of microcystis aeruginosa chlorophyll provided in embodiments of the present invention;

FIG. 4 shows scanning electron micrographs of scenedesmus cells provided in embodiments of the present invention;

FIG. 5 shows scanning electron micrographs of chlorella cells provided in embodiments of the present invention;

FIG. 6 shows scanning electron micrographs of microcystis aeruginosa cells provided in embodiments of the present invention; and

FIG. 7 is a schematic diagram of a change curve between copper on dissolution rate of 50 ppm of copper-carbon composite nanomaterial in natural water body and time provided in embodiments of the present invention.

### DETAILED DESCRIPTION OF PREFERRED EMBODIMENTS

The technical solutions in the embodiments of the present invention will be described below clearly and completely. Apparently, the described embodiments are only some of the embodiments of the present invention, not all of the embodiments. Based on the embodiments in the present invention, all other embodiments obtained by those ordinary skilled in the art on the premise of not contributing creative labor belong to a protection scope of the present invention.

The embodiments of the present invention provide a use of a copper-carbon composite nanomaterial in algae control. The copper-carbon composite nanomaterial is used to inhibit algae growth.

Due to special features, nanomaterial has distinctive physical and chemical properties, such as surface effect, volume effect, quantum size effect and the like, and has wide application prospect and attracts much attention in the aspects of catalysis, medicine, water body treatment and the like. The copper-carbon composite nanomaterial used for algae control is a nanoparticle of a core-shell structure with copper-carbon component prepared by a plant fiber template.

Under normal physiological conditions, free copper ions exist in cells. Under the condition of copper overload, the free copper ions are accumulated to form free radical oxidized protein, lipid and DNA. In copper compounds, monovalent copper has the strongest antibiotic, antiseptic, aseptic and disinfection efficacy. The diameter of the nanoparticle prepared by the technology is about from several nanometers to 50 nanometers, and the thickness of a porous carbon shell is between 2 to 4 nanometers. The copper-carbon composite nanomaterial has small size, large specific surface area, high surface activity and easy realization of biological effect. The nanoparticle with copper/carbon-core/shell structure forms a copper-cuprous oxide (Cu—Cu2O) balance system through the action with the environment, and copper oxide (CuO) is not generated in the system. Under the condition of oxygen enrichment, a dense cuprous oxide layer is only generated due to a special carbon shell on a contact surface between a copper core and the outside through the porous carbon shell; and a special balance system is formed by the copper core and internal metal copper. Because stable cuprous oxide has very low solubility, the nanoparticle has very low copper ion dissolution rate in a water solution and ensures the stability of the nanoparticle in the water solution. The generated copper-cuprous oxide nanoparticle system can be reduced into the original nanoparticle with copper/carbon-core/shell structure by simple thermal shock or other reduction conditions.

The use of the copper-carbon composite nanomaterial in algae control is described below through specific experiments:

I A small experiment is conducted in a laboratory.

In the laboratory, a control experiment is conducted by taking the copper-carbon composite nanomaterial as main material and taking copper oxide, copper sulfate and activated carbon as auxiliary materials to detect activity inhibition effects of the copper-carbon composite nanomaterial on scenedesmus (green algae), chlorella (green algae) and microcystis aeruginosa (blue algae). The experiment tests the a content of chlorophyll, the copper ion dissolution rate and the like, and makes scanning electron microscope appearance observation.

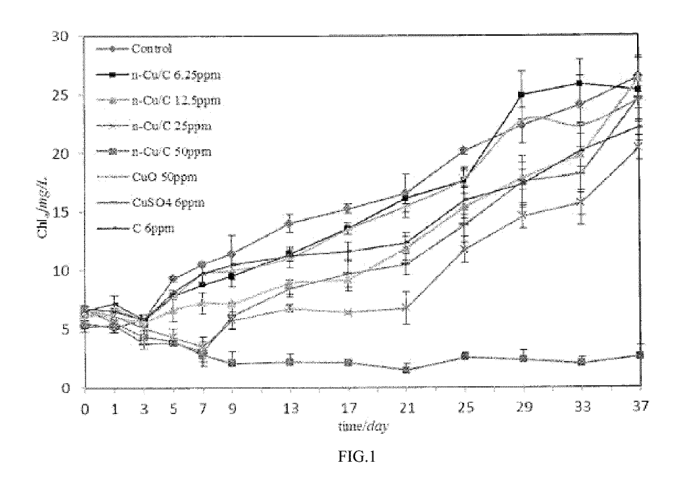

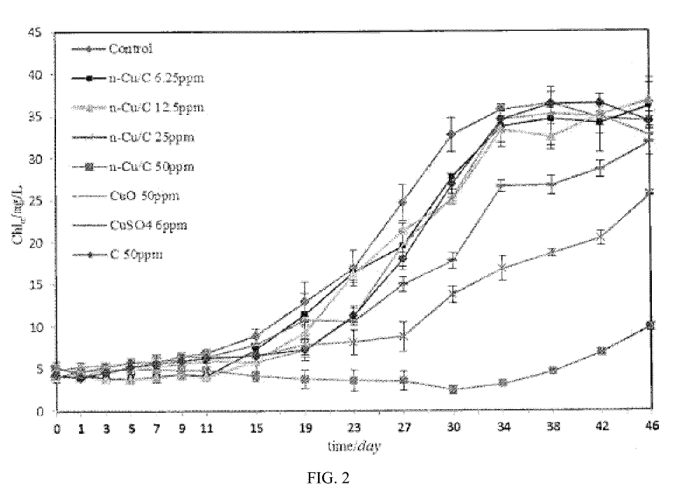

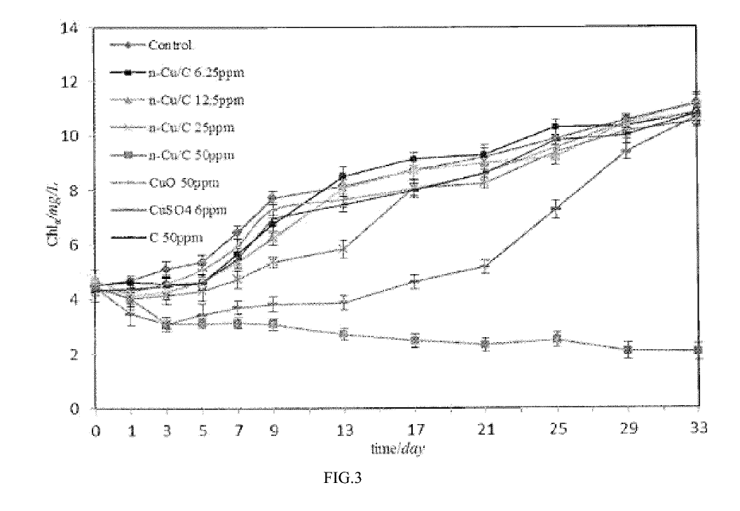

The α content of chlorophyll is determined; the concentrations of the copper-carbon composite nanomaterial are respectively 6.25 ppm, 12.5 ppm, 25 ppm and 50 ppm. The concentrations of activated carbon C, copper oxide CuO and copper sulfate CuSO4 are respectively 50 ppm, 50 ppm and 6 ppm. Comparison is made with a blank sample without the copper-carbon composite nanomaterial, and the change of the a content of chlorophyll with time is detected. Specific change is shown in FIG. 1 to FIG. 3.

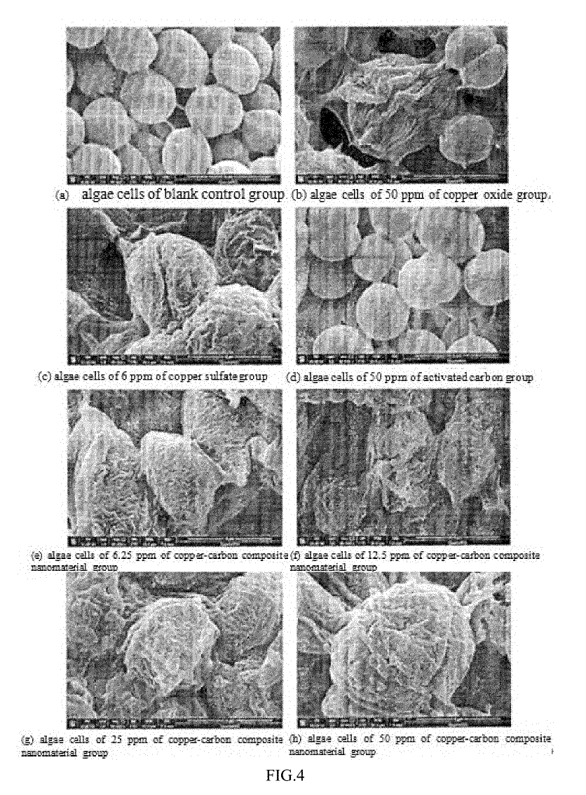

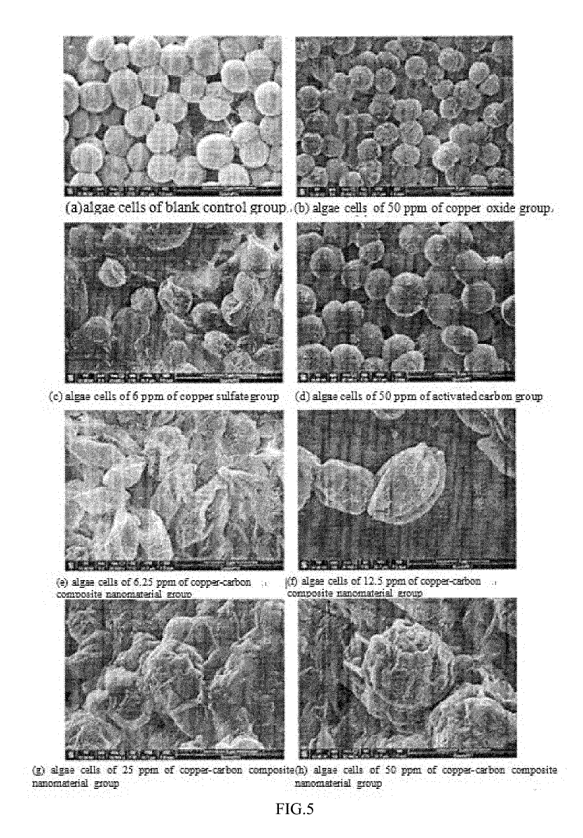

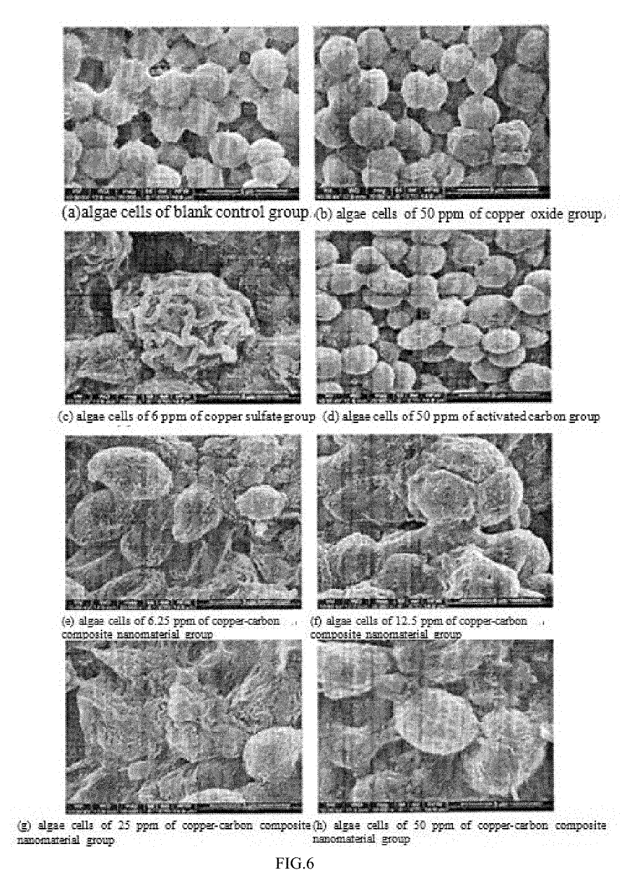

It can be seen from the scanning electron micrographs of algae cells of FIG. (a) to FIG. (h) in FIG. 4 to FIG. 6: cell shapes of the algae cells in a blank sample group are regular and very close. The algae cells of an activated carbon group have little difference from the algae cells of the blank group. Most of algae cells of a copper oxide group are similar to the algae cells of the blank sample group, but some cells are obviously changed. It indicates that the two materials have no obvious effect on the algae cells. Appearances of the algae cells of the copper sulfate group are completely changed. The algae cells in the copper-carbon composite nanomaterial groups of different concentrations are changed completely from low concentration to high concentration. The higher the concentration is, the more obvious the change of the appearances of the algae cells is.

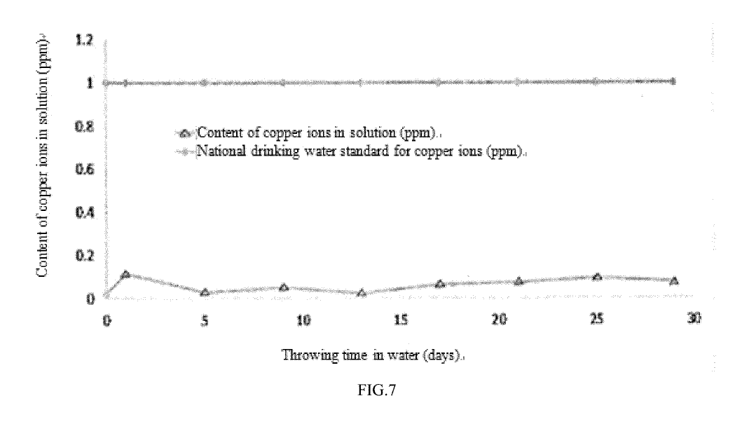

FIG. 7 is a schematic diagram of a change curve between copper ion dissolution rate of 50 ppm of copper-carbon composite nanomaterial in natural water body and time. The copper ion dissolution rate of 50 ppm of copper-carbon composite nanomaterial in the natural water body is basically stabilized, to be below 0.2 ppm, lower than the national drinking water standard for copper ions (1 ppm).

Conclusions of the small experiment in the laboratory:

1) The inhibition action of the copper-carbon composite nanomaterial for algae growth persists for a longer time. The inhibition time of 50 ppm of copper-carbon composite nanomaterial is more than 30 days, while the inhibition time of the copper sulfate is 7-9 days and the copper oxide and the activated carbon have no obvious inhibition action. Through the change of a photosynthetic rate, 50 ppm of copper-carbon composite nanomaterial rapidly reduces the activity of the algae and the effect is more obvious than that of the copper sulfate, which can infer that the activity of the algae is affected to a certain degree. The actual experiment proves that the copper-carbon composite nanomaterial with a concentration of 50 ppm to 150 ppm has the best algae control effect.

2) It can be found from the scanning electron microscope results that the algae cells treated by the copper-carbon composite nanomaterial have crinkly surfaces and large volume, and the appearances of the algae cells are changed. Therefore, the copper-carbon composite nanomaterial changes cell membranes of the algae cells, and further achieves the algae control effect.

3) Determination of the copper ion dissolution rate shows that when the copper-carbon composite nanomaterial is used for algae control, the content of copper ions in the water satisfies the national drinking water standard, i.e., the material does not generate secondary pollution to the water body and is environmentally friendly.

II An outdoor extensive experiment is made.

Cultivation of mixed algae and throwing of powdery copper-carbon composite nanomaterial: mixed algae such as blue algae and the like obtained from the water area of Tai Lake are thrown into outdoor A and B pools. The copper-carbon composite nanomaterial is added to B pool. The A pool is used as a control group to detect the killing effect and the activity inhibition effect of the copper-carbon composite nonmaterial on the mixed algae. The copper-carbon composite nanomaterial is thrown to kill and inhibit the algae in the outdoor pools. The thrown copper-carbon composite nanomaterial is in powder form.

The mixed algae are put into the outdoor A and B pools and cultured. After the mixed algae are stirred, the mixed algae are sampled to determine algae content, nitrogen content and phosphorus content until the content is not changed basically. Note: The daily mean effective illumination (9-10 a.m.) of B pool is longer than that of A pool by about 1 hour. The powdery copper-carbon composite nanomaterial is added to B pool, and has a concentration of 25 ppm.

The experiment for the mixed algae shows that: the total nitrogen content and the total phosphorus content of A pool and B pool are not changed basically, which indicates that the pools are always above the eutrophication level. The chlorophyll content of A pool has an increasing trend, and the chlorophyll content of B pool is always decreased, which indicates that the powdery copper-carbon composite nanomaterial also has the inhibition action on the growth of the mixed algae.

In addition, the copper-carbon composite nanomaterial includes copper-carbon nano textile fibers or foam. For the net cages used for cultivation and prepared by the copper-carbon nano textile fibers or foam, the algae cannot grow on the surfaces of the net cages, thereby effectively inhibit algae growth and avoiding blocking meshes of the net cages due to algae growth. The copper-carbon composite nanomaterial has certain feasibility and can solve the great problem which has not been solved so far in the cage culture.

In conclusion, compared with other algae inhibiting means such as copper sulfate, copper oxide and the like, 50 ppm of powdery copper-carbon composite nanomaterial can play an obvious inhibition action on the growth of different algae groups of scenedesmus, chlorella and microcystis aeruginosa, and the inhibition time is about 30 days, while the inhibition time of the copper sulfate is 7 days and the copper oxide and the activated carbon have no obvious inhibition action on algae growth. The change of the α content of chlorophyll in the early experiment proves that the powdery copper-carbon composite nanomaterial has a long-term inhibition action on algae growth. The copper ion dissolution rate (lower than 0.2 ppm) of 50 ppm of copper-carbon composite nanomaterial in the natural water body is lower than the national drinking water standard for copper ions (1 ppm). The copper-carbon composite nanomaterial does not generate, secondary pollution to the environment while effectively controlling the algae. By employing the copper-carbon composite nanomaterial to perform algae control, the present invention eliminates the pollution resulting from algal blooms, and improves the water environment.

The above only describes preferred embodiments of the present invention, not intended to limit the present invention. Any modification, equivalent replacement, improvement and the like made within the spirit and principle of the present invention shall be included in the protection scope of the present invention.

We claim:

1. A use of a copper-carbon composite nanomaterial in algae control, wherein the copper-carbon composite nanomaterial is used to inhibit algae growth.

2. The use of the copper-carbon composite nanomaterial in algae control according to claim 1, wherein the copper-carbon composite nanomaterial used for algae control is a nanoparticle of a core-shell structure with copper-carbon component prepared by a plant fiber template.

3. The use of the copper-carbon composite nanomaterial in algae control according to claim 1, wherein the concentration of the copper-carbon composite nanomaterial used for algae control is 50 ppm to 150 ppm.

4. The use of the copper-carbon composite nanomaterial in algae control according to claim 1, wherein algae in outdoor pools are killed and inhibited by throwing the copper-carbon composite nanomaterial, and the thrown copper-carbon composite nanomaterial is in powder form.

5. The use of the copper-carbon composite nanomaterial in algae control according to claim 1, wherein the copper-carbon composite nanomaterial comprises copper-carbon nano textile fibers or foam; and net cages used for cultivation and prepared by the copper-carbon nano textile fibers or foam can be used to effectively inhibit algae growth and avoid blocking meshes of the net cages due to algae growth.
